(19) United States
(12) Patent Application Publication
(10) Pub. No.: US 2004/0186714 A1
(43) Pub. Date: Sep. 23, 2004

(54) Speech recognition improvement through post-processsing

(75) Inventor: James K. Baker, Maitland, FL (US)

Correspondence Address: FOLEY AND LARDNER, SUITE 500, 3000 K STREET NW, WASHINGTON, DC, 20007, US

(73) Assignee: Aurilab, LLC

(21) Appl. No.: 10/389,798

(22) Filed: Mar. 18, 2003

(51) Int. Cl. G10L 15/12; G10L 15/08

(52) U.S. Cl. 704/236

(57) ABSTRACT

A method, program product and system for speech recognition for use with a base speech recognition process, but which does not affect scoring models in the base speech recognition process, the method comprising in one embodiment: obtaining an output hypothesis from a base speech recognition process that uses a first set of scoring models; obtaining a set of alternative hypotheses; scoring the set of alternative hypotheses based on a second set of different scoring models that is separate from and external to the base speech recognition process and does not affect the scoring models thereof; and selecting a hypothesis with a best score.

### BACKGROUND OF THE INVENTION

Although the performance of speech recognition system has improved substantially in recent years, there is still need for further improvement. In particular, sometimes a speech recognition system makes a particular error even when the user repeatedly corrects that error. One reason that a given speech recognition system might be unable to correct a particular error is that the system is simultaneously modeling many different speech elements. Sometimes changing the models to fix a particular error will introduce errors in other situations.

### SUMMARY OF THE INVENTION

The present invention comprises, in one embodiment a method for speech recognition for use with a base speech recognition process, but which does not affect scoring models in the base speech recognition process, comprising: obtaining an output hypothesis from a base speech recognition process that uses a first set of scoring models; obtaining a set of alternative hypotheses; scoring the output hypothesis and each one in the set of alternative hypotheses based on a second set of different scoring models that is separate from and external to the base speech recognition process and does not affect the scoring models thereof; and selecting a hypothesis with a best score.

In a further embodiment of the present invention, the steps are provided of presenting the best scoring hypothesis, collecting error correction or other feedback information, and using the collected information to perform at least one of improving the second set of scoring models or training the base speech recognition process.

In a further embodiment of the present invention, the second set of scoring models may be changed without changing the first set of models or the scores or relative rankings produced by the first set of models.

In a further embodiment of the present invention, the obtaining a list of alternative hypotheses step comprises selecting a reduced number of hypotheses with good scores as determined by the first set of scoring models, wherein the reduced number is less than all of the hypotheses considered by the first speech recognition process.

In a further embodiment of the present invention, the steps are provided of comparing two hypotheses with good scores to determine which speech element or elements differ; and rescoring with the second set of scoring models at least one of the speech element or elements that differ.

In a further embodiment of the present invention, the obtaining a list of alternative hypotheses step comprises adding at least one new hypothesis to the output hypothesis from the first speech recognition process.

In a further embodiment of the present invention, the adding at least one new hypothesis step comprises the steps of detecting a confusable one or more speech elements in the output hypothesis; selecting an alternative for at least one of the confusable one or more speech elements; and creating as an alternative hypothesis a new hypothesis using the alternative speech element.

In a further embodiment of the present invention, the selection of the alternative for the at least one confusable is made from a database of confusable speech elements or speech elements that are often deleted in speech.

In a further embodiment of the present invention, the second set of scoring models includes at least one of an improved set of acoustic models and a language model.

In a further embodiment of the present invention, if the second set of scoring models does not have data pertaining to any of the speech elements which differ between the top choice hypothesis and an alternate hypothesis, then not changing the relative rank between the top choice hypothesis and the said alternate hypothesis.

In a further embodiment of the present invention, the second set of scoring models includes at least one discriminative scoring model.

In a further embodiment of the present invention, the step is provided of training the discriminative model by a back-propagation algorithm to discriminate between speech elements where error information has been collected for these speech elements.

In a further embodiment of the present invention, the step is provided of training the discriminative scoring model using less than 50% of the training data normally used to train a standard scoring model.

In a further embodiment of the present invention, the collecting information step comprises presenting a screen interface to a user for receiving correction information.

In a further embodiment of the present invention, the collecting information step comprises collecting statistics on errors of the first speech recognition process.

In a further embodiment of the present invention, the using the collected information step comprises the steps of determining selected errors that are repeated in the first speech recognition process; and repeatedly calling a training mechanism in the first speech recognition process to train on the selected errors to thereby give more weight in the training to these selected errors.

In a further embodiment of the present invention, a program product is provided for speech recognition for use with a base speech recognition process, but which does not affect scoring models in the base speech recognition process, comprising machine-readable program code that, when executed, will cause a machine to perform the following steps: obtaining an output hypothesis from a base speech recognition process that uses a first set of scoring models; obtaining a set of alternative hypotheses; scoring the output hypothesis and each one in the set of alternative hypotheses based on a second set of different scoring models that is separate from and external to the base speech recognition process and does not affect the scoring models thereof; and selecting a hypothesis with a best score.

In a further embodiment of the present invention, a system is provided for speech recognition for use with a base speech recognition process, but which does not affect scoring models in the base speech recognition process, comprising: a component for obtaining an output hypothesis from a base speech recognition process that uses a first set of scoring models; a component for obtaining a set of alternative hypotheses; a component for scoring the output hypothesis and each one in the set of alternative hypotheses based on a second set of different scoring models that is separate from and external to the base speech recognition process and does not affect the scoring models thereof; and a component for selecting a hypothesis with a best score.

### BRIEF DESCRIPTION OF THE DRAWING

FIG. 1 is a block diagram of a flowchart of one embodiment of the present invention.

FIG. 2 is a block diagram of a flowchart of a further embodiment of the present invention.

FIG. 3 is a block diagram of a flowchart of a further embodiment of the present invention.

FIG. 4 is a block diagram of a flowchart of a further embodiment of the present invention.

FIG. 5 is a block diagram of a flowchart of a further embodiment of the present invention.

### DETAILED DESCRIPTION OF EMBODIMENTS OF THE INVENTION

Definitions

The following terms may be used in the description of the invention and include new terms and terms that are given special meanings.

“Linguistic element” is a unit of written or spoken language.

“Speech element” is an interval of speech with an associated name. The name may be the word, syllable or phoneme being spoken during the interval of speech, or may be an abstract symbol such as an automatically generated phonetic symbol that represents the system's labeling of the sound that is heard during the speech interval.

“Frame” for purposes of this invention is a fixed or variable unit of time which is the shortest time unit analyzed by a given system or subsystem. A frame may be a fixed unit, such as 10 milliseconds in a system which performs spectral signal processing once every 10 milliseconds, or it may be a data dependent variable unit such as an estimated pitch period or the interval that a phoneme recognizer has associated with a particular recognized phoneme or phonetic segment. Note that, contrary to prior art systems, the use of the word “frame” does not imply that the time unit is a fixed interval or that the same frames are used in all subsystems of a given system.

“Score” is a numerical evaluation of how well a given hypothesis matches some set of observations. Depending on the conventions in a particular implementation, better matches might be represented by higher scores (such as with probabilities or logarithms of probabilities) or by lower scores (such as with negative log probabilities or spectral distances). Scores may be either positive or negative. The score may also include a measure of the relative likelihood of the sequence of linguistic elements associated with the given hypothesis, such as the a priori probability of the word sequence in a sentence.

“Dynamic programming match scoring” is a process of computing the degree of match between a network or a sequence of models and a sequence of acoustic observations by using dynamic programming. The dynamic programming match process may also be used to match or time-align two sequences of acoustic observations or to match two models or networks. The dynamic programming computation can be used for example to find the best scoring path through a network or to find the sum of the probabilities of all the paths through the network. The prior usage of the term “dynamic programming” varies. It is sometimes used specifically to mean a “best path match” but its usage for purposes of this patent covers the broader class of related computational methods, including “best path match,” “sum of paths” match and approximations thereto. A time alignment of the model to the sequence of acoustic observations is generally available as a side effect of the dynamic programming computation of the match score. Dynamic programming may also be used to compute the degree of match between two models or networks (rather than between a model and a sequence of observations). Given a distance measure that is not based on a set of models, such as spectral distance, dynamic programming may also be used to match and directly time-align two instances of speech elements.

“Best path match” is a process of computing the match between a network and a sequence of acoustic observations in which, at each node at each point in the acoustic sequence, the cumulative score for the node is based on choosing the best path for getting to that node at that point in the acoustic sequence. In some examples, the best path scores are computed by a version of dynamic programming sometimes called the Viterbi algorithm from its use in decoding convolutional codes. It may also be called the Dykstra algorithm or the Bellman algorithm from independent earlier work on the general best scoring path problem.

“Sum of paths match” is a process of computing a match between a network or a sequence of models and a sequence of acoustic observations in which, at each node at each point in the acoustic sequence, the cumulative score for the node is based on adding the probabilities of all the paths that lead to that node at that point in the acoustic sequence. The sum of paths scores in some examples may be computed by a dynamic programming computation that is sometimes called the forward-backward algorithm (actually, only the forward pass is needed for computing the match score) because it is used as the forward pass in training hidden Markov models with the Baum-Welch algorithm.

“Hypothesis” is a hypothetical proposition partially or completely specifying the values for some set of speech elements. Thus, a hypothesis is a grouping of speech elements, which may or may not be in sequence. However, in many speech recognition implementations, the hypothesis will be a sequence or a combination of sequences of speech elements. Corresponding to any hypothesis is a set of models, which may, as noted above in some embodiments, be a sequence of models that represent the speech elements. Thus, a match score for any hypothesis against a given set of acoustic observations, in some embodiments, is actually a match score for the concatenation of the set of models for the speech elements in the hypothesis.

“Set of hypotheses” is a collection of hypotheses that may have additional information or structural organization supplied by a recognition system. For example, a priority queue is a set of hypotheses that has been rank ordered by some priority criterion; an n-best list is a set of hypotheses that has been selected by a recognition system as the best matching hypotheses that the system was able to find in its search. A hypothesis lattice or speech element lattice is a compact network representation of a set of hypotheses comprising the best hypotheses found by the recognition process in which each path through the lattice represents a selected hypothesis.

“Selected set of hypotheses” is the set of hypotheses returned by a recognition system as the best matching hypotheses that have been found by the recognition search process. The selected set of hypotheses may be represented, for example, explicitly as an n-best list or implicitly as the set of paths through a lattice. In some cases a recognition system may select only a single hypothesis, in which case the selected set is a one element set. Generally, the hypotheses in the selected set of hypotheses will be complete sentence hypotheses; that is, the speech elements in each hypothesis will have been matched against the acoustic observations corresponding to the entire sentence. In some implementations, however, a recognition system may present a selected set of hypotheses to a user or to an application or analysis program before the recognition process is completed, in which case the selected set of hypotheses may also include partial sentence hypotheses. Such an implementation may be used, for example, when the system is getting feedback from the user or program to help complete the recognition process.

“Sentence” is an interval of speech or a sequence of speech elements that is treated as a complete unit for search or hypothesis evaluation. Generally, the speech will be broken into sentence length units using an acoustic criterion such as an interval of silence. However, a sentence may contain internal intervals of silence and, on the other hand, the speech may be broken into sentence units due to grammatical criteria even when there is no interval of silence. The term sentence is also used to refer to the complete unit for search or hypothesis evaluation in situations in which the speech may not have the grammatical form of a sentence, such as a database entry, or in which a system is analyzing as a complete unit an element, such as a phrase, that is shorter than a conventional sentence.

“Modeling” is the process of evaluating how well a given sequence of speech elements match a given set of observations typically by computing how a set of models for the given speech elements might have generated the given observations. In probability modeling, the evaluation of a hypothesis might be computed by estimating the probability of the given sequence of elements generating the given set of observations in a random process specified by the probability values in the models. Other forms of models, such as neural networks may directly compute match scores without explicitly associating the model with a probability interpretation, or they may empirically estimate an a posteriori probability distribution without representing the associated generative stochastic process.

“Training” is the process of estimating the parameters or sufficient statistics of a model from a set of samples in which the identities of the elements are known or are assumed to be known. In supervised training of acoustic models, a transcript of the sequence of speech elements is known, or the speaker has read from a known script. In unsupervised training, there is no known script or transcript other than that available from unverified recognition. In one form of semi-supervised training, a user may not have explicitly verified a transcript but may have done so implicitly by not making any error corrections when an opportunity to do so was provided.

“Acoustic model” is a model for generating a sequence of acoustic observations, given a sequence of speech elements. The acoustic model, for example, may be a model of a hidden stochastic process. The hidden stochastic process would generate a sequence of speech elements and for each speech element would generate a sequence of zero or more acoustic observations. The acoustic observations may be either (continuous) physical measurements derived from the acoustic waveform, such as amplitude as a function of frequency and time, or may be observations of a discrete finite set of labels, such as produced by a vector quantizer as used in speech compression or produced as the output of a phonetic recognizer. The continuous physical measurements would generally be modeled by some form of parametric probability distribution such as a Gaussian distribution or a mixture of Gaussian distributions. Each Gaussian distribution would be characterized by the mean of each observation measurement and the covariance matrix. If the covariance matrix is assumed to be diagonal, then the multi-variant Gaussian distribution would be characterized by the mean and the variance of each of the observation measurements. The observations from a finite set of labels would generally be modeled as a non-parametric discrete probability distribution. However, other forms of acoustic models could be used. For example, match scores could be computed using neural networks, which might or might not be trained to approximate a posteriori probability estimates. Alternately, spectral distance measurements could be used without an underlying probability model, or fuzzy logic could be used rather than probability estimates.

“Language model” is a model for generating a sequence of linguistic elements subject to a grammar or to a statistical model for the probability of a particular linguistic element given the values of zero or more of the linguistic elements of context for the particular speech element.

“General Language Model” may be either a pure statistical language model, that is, a language model that includes no explicit grammar, or a grammar-based language model that includes an explicit grammar and may also have a statistical component.

“Grammar” is a formal specification of which word sequences or sentences are legal (or grammatical) word sequences. There are many ways to implement a grammar specification. One way to specify a grammar is by means of a set of rewrite rules of a form familiar to linguistics and to writers of compilers for computer languages. Another way to specify a grammar is as a state-space or network. For each state in the state-space or node in the network, only certain words or linguistic elements are allowed to be the next linguistic element in the sequence. For each such word or linguistic element, there is a specification (say by a labeled arc in the network) as to what the state of the system will be at the end of that next word (say by following the arc to the node at the end of the arc). A third form of grammar representation is as a database of all legal sentences.

“Grammar state” is a representation of the fact that, for purposes of determining which sequences of linguistic elements form a grammatical sentence, certain sets of sentence-initial sequences may all be considered equivalent. In a finite-state grammar, each grammar state represents a set of sentence-initial sequences of linguistic elements. The set of sequences of linguistic elements associated with a given state is the set of sequences that, starting from the beginning of the sentence, lead to the given state. The states in a finite-state grammar may also be represented as the nodes in a directed graph or network, with a linguistic element as the label on each arc of the graph. The set of sequences of linguistic elements of a given state correspond to the sequences of linguistic element labels on the arcs in the set of paths that lead to the node that corresponds to the given state. For purposes of determining what continuation sequences are grammatical under the given grammar, all sequences that lead to the same state are treated as equivalent. All that matters about a sentence-initial sequence of linguistic elements (or a path in the directed graph) is what state (or node) it leads to. Generally, speech recognition systems use a finite state grammar, or a finite (though possibly very large) statistical language model. However, some embodiments may use a more complex grammar such as a context-free grammar, which would correspond to a denumerable, but infinite number of states. In some embodiments for context-free grammars, non-terminal symbols play a role similar to states in a finite-state grammar, but the associated sequence of linguistic elements for a non-terminal symbol will be for some span of linguistic elements that may be in the middle of the sentence rather than necessarily starting at the beginning of the sentence. Any finite-state grammar may alternately be represented as a context-free grammar.

“Stochastic grammar” is a grammar that also includes a model of the probability of each legal sequence of linguistic elements.

“Pure statistical language model” is a statistical language model that has no grammatical component. In a pure statistical language model, generally every possible sequence of linguistic elements will have a non-zero probability.

“Pass.” A simple speech recognition system performs the search and evaluation process in one pass, usually proceeding generally from left to right, that is, from the beginning of the sentence to the end. A multi-pass recognition system performs multiple passes in which each pass includes a search and evaluation process similar to the complete recognition process of a one-pass recognition system. In a multi-pass recognition system, the second pass may, but is not required to be, performed backwards in time. In a multi-pass system, the results of earlier recognition passes may be used to supply look-ahead information for later passes.

“Discriminative scoring” is a scoring process in which a score is computed for a relative degree of merit of two alternative hypotheses. The discriminative score between two hypotheses does not provide a measure of an absolute score or a degree of merit of either hypothesis individually and independently and is not appropriate to be used when comparing either of the two hypotheses with any third hypothesis.

“Discriminative training” is a process of training parameters of a model or collection of models through an optimization of the amount of discrimination among a set of patterns rather than through an optimization of each model to best fit the distributions of values observed for instances of that model in training data, as is done in conventional training. Sometimes, even when the discriminative optimization is performed on the same training data, the parameter values that optimize the discrimination are very different from the parameter values of conventional training based on a fit to the data.

A set of models is “external” to a given pattern recognition process if the set of models is created or trained without access to the models of the given pattern recognition process.

The invention is described below with reference to drawings. These drawings illustrate certain details of specific embodiments that implement the systems and methods and programs of the present invention. However, describing the invention with drawings should not be construed as imposing, on the invention, any limitations that may be present in the drawings. The present invention contemplates methods, systems and program products on any computer readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also be included within the scope of machine-readable media. Machine-executable instructions comprise, for example, instructions and data which cause a general purpose computer, special purpose computer, or special purpose processing machines to perform a certain function or group of functions.

Embodiments of the invention will be described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated machine-readable media provide nonvolatile storage of machine-executable instructions, data structures, program modules and other data for the computer.

The present invention allows improvement in a base speech recognition system without the necessity of changing the base speech recognition system itself (although such changes could be made if desired). It even allows improvement without access to the source code of the underlying base speech recognition system. For example, this invention could operate as an add-on product to a commercially available recognition system.

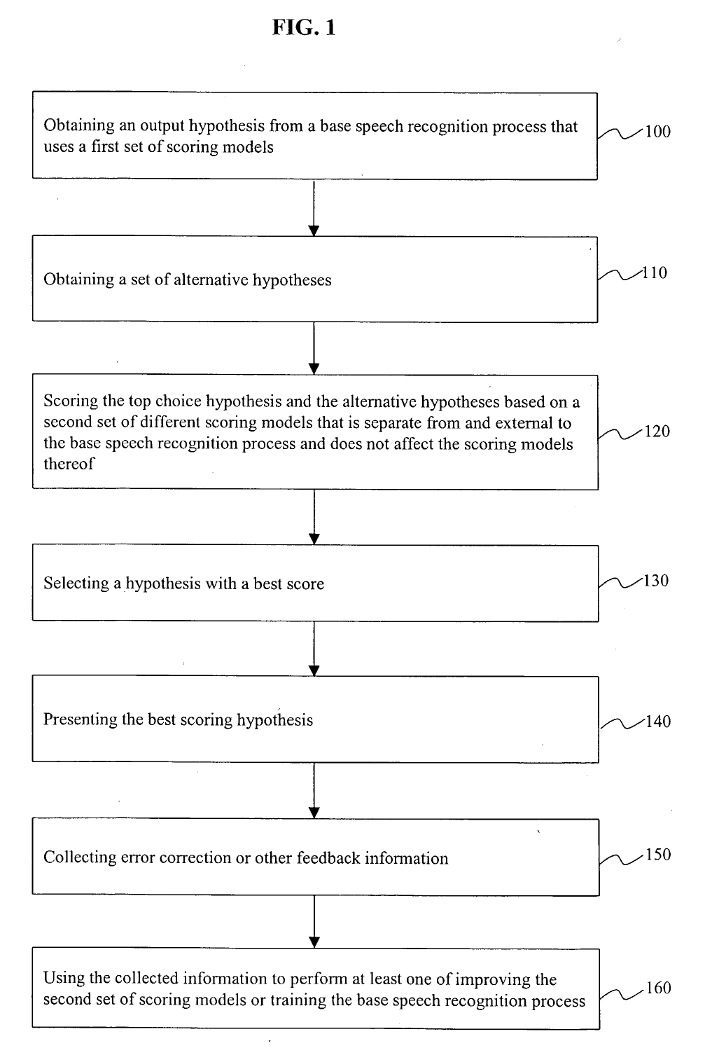

Referring to FIG. 1, one embodiment of the present invention is illustrated. With reference to block 100, an output hypothesis from a base speech recognition process that uses a first set of scoring models is obtained. The output hypothesis may comprise, for example, a sequence of speech elements such as the base speech recognition system would send to any application program as the recognition system's choice for the sequence of speech elements corresponding to a given interval of speech.

Referring to block 110, a set of alternative hypotheses is obtained. In one embodiment, this step might be implemented by obtaining from the output from the base recognition process a set of alternate choices that the recognition system considers to be nearly as likely as the chosen sequence. If available, this embodiment might also retrieve from the recognition system the evaluation score for the top choice and any alternate choices, preferably including separate scores from acoustic modeling and language modeling. In a further embodiment, this step could be implemented by obtaining a set of alternate hypotheses from the external system itself by using the external system's own knowledge of which speech elements are likely to be confused in order to expand the single choice, or the list of alternate choices, supplied by the recognition system to a list, or a more complete list, of possible alternate choices.

Referring to block 120, the top choice and one or more alternative hypotheses from the set of alternative hypotheses are scored based on a second set of different scoring models that is separate from and external to the base speech recognition process and does not affect the scoring models thereof. In one implementation of the scoring block 120, the external system uses its own acoustic models and language model, external to the base speech recognition system, to rescore each hypothesis on the list of alternate choices that it has generated. In block 130 a hypothesis is then selected with a best score.

Note that the modeling task required for the preferred embodiment of the rescoring system is somewhat different than the modeling task required in the base speech recognition system. The preferred embodiment of the rescoring system does not need to do a search among all possible sequences of speech elements, and doesn't even need to be able to compute a score for each such hypothesis. For example, in one embodiment of the rescoring system, the rescoring system has its own model for each speech element and computes a match score for each hypothesized sequence of speech elements, but only computes such scores for each hypothesis on the expanded list of alternate choices and does not perform a search for other hypotheses.

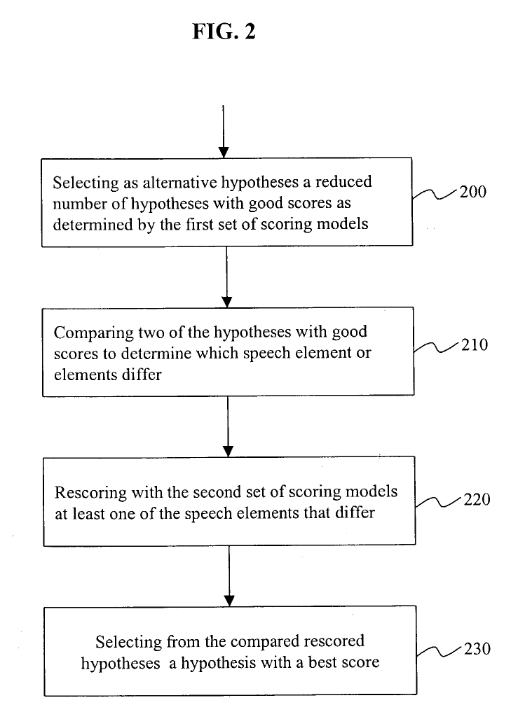

Referring to FIG. 2, an embodiment of the invention is disclosed that is premised, at least in part, on obtaining alternate hypotheses and scores therefor from the base speech recognition process, where the scores are based on the scoring models used in the base speech recognition process. Accordingly, in block 200 a reduced number of alternative hypotheses with good scores as determined by the scoring models used in the base speech recognition process are selected. The term “good score” simply means that a subset of all of the alternatives considered by the based speech recognition process that have better scores than other of the alternatives are selected.

Referring to block 210, two of the selected hypotheses with good scores are compared to determine which speech element or elements in the two hypotheses differ.

Referring to block 220, at least one of the speech elements that differ are rescored in the selected hypotheses using the second set of scoring models.

Referring to block 230, the hypothesis with a best score is then selected from the compared rescored hypotheses.

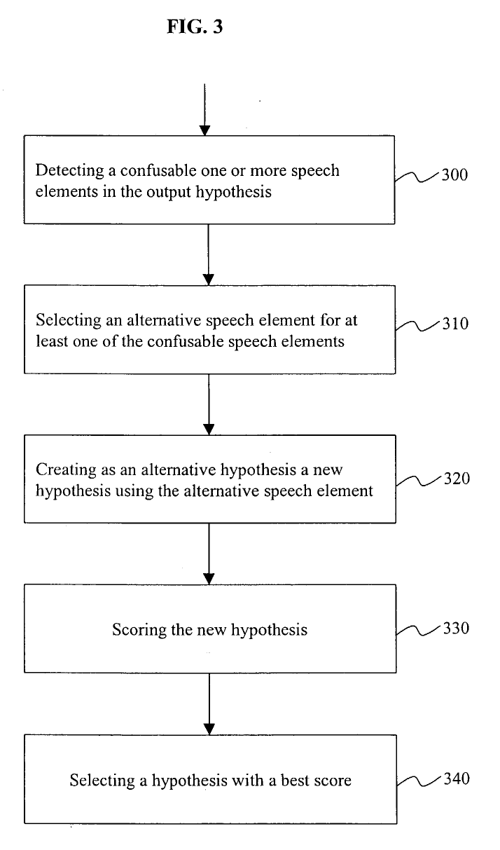

Referring to FIG. 3, a further embodiment of the present invention is described. In block 300 a confusable one or more speech elements in the output hypothesis are detected. In one embodiment, this detection may be accomplished by referring to a database of confusable elements or elements that are often deleted in speech.

Referring to block 310, an alternative speech element is obtained for at least one of the confusable speech elements. By way of example, this alternative speech element could be obtained from the aforementioned database of confusable speech elements or elements that are often deleted in speech.

Referring to block 320, a new hypothesis is created using the alternative speech element.

Referring to block 330, the new hypothesis is scored. This scoring could be performed using the second set of scoring models for example.

In block 340, the hypothesis with the best score is selected.

In a yet further embodiment of the present invention, the rescoring system does not have a model for each speech element, but rather uses discriminative models. This second embodiment can use a discriminative model that only estimates the difference in score between two confusable alternatives. This difference model need not give a separate score for each hypothesis. In particular the difference model does not need to give a score for each hypothesis such as could be used either as an absolute score or in comparison with other hypotheses, but need only focus on the designated pair.

For example, in this second embodiment, a neural network may be trained by a back-propagation algorithm (see, for example, Huang, Acero and Hon, p. 163) to discriminate between two speech elements, given a moderate number of instances of each of the two elements. The activation scores in this network would not necessarily be appropriate in comparing either of the two speech elements with a third element and scores computed in a separate network. Also, it will generally be feasible to train the discriminative network using much less training data than would be required to train a standard model. Such a discriminative network could use acoustic data or language model context, or even both.

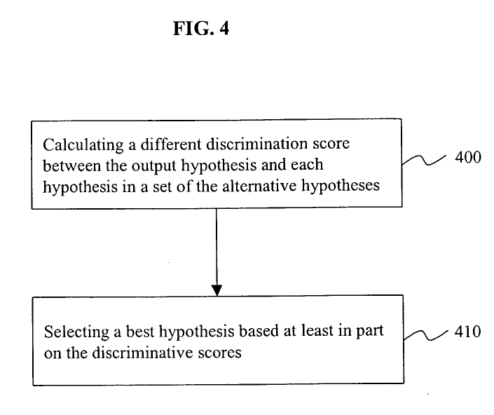

One embodiment of a rescoring system with discriminative scores is illustrated in FIG. 4. Referring to block 400, discriminative scores are computed only between the hypothesis that was selected as top choice (the output hypothesis) by the base recognition system on the one hand and each hypothesis in a set of the alternate hypotheses on the other hand. In this embodiment, the alternate hypotheses would be considered in order as ranked by the base recognition system. Referring to block 410, a first alternate hypothesis, if any, that is preferred over the original top choice hypothesis based at least in part on the discriminative rescores will be chosen as the new top choice hypothesis.

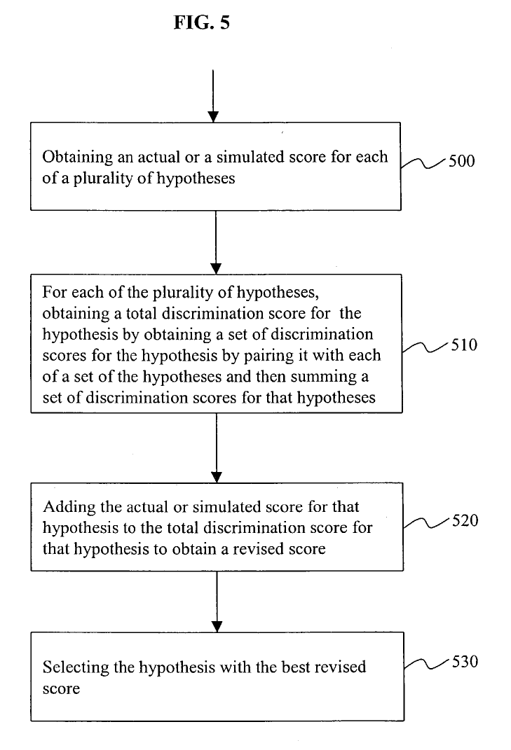

Another embodiment of a rescoring system with discriminative scores in accordance with the present invention is illustrated in FIG. 5. This rescoring system would use the hypothesis scores from the base recognition system in combination with the discriminative scores. If scores from the base recognition system are not available for alternative hypotheses, then this embodiment would use simulated scores derived, for example, from the rank order of the hypotheses. To estimate these simulated scores, a neural net model would be created that would take as an input the rank of each alternative hypothesis and generate as an output an estimated difference in score between the top choice hypothesis and the hypothesis of each rank. The neural net could be trained, for example, by running simulated recognition on training data and training the neural net parameters using the back-propagation algorithm, which is well-known to those skilled in the art of neural nets (see, for example, Huang, Acero and Hon, p. 163). Block 500 illustrates the operation of obtaining an actual or simulated score for each of a plurality of hypotheses, including the output hypothesis and the set of alternative hypotheses.

Whether using actual scores from the base recognition system or using scores simulated from the rank of each hypothesis, this preferred embodiment would compute a new score for a given hypothesis by adding the base (or simulated) score for the given hypothesis to the sum of all the discrimination scores for discriminations in which the given hypothesis is one of the members of the pair being discriminated. That is, the new score would be determined by equation (1).

RevisedScore(H)=BaseScore(H)+Σ_{K}DiscrimScore(H,K) (1)

This operation of, for each of the plurality of hypotheses, obtaining a total discrimination score for the hypothesis by obtaining a separate discrimination score for that hypothesis paired with a different hypothesis and then summing a plurality of these discrimination scores for that hypothesis is represented by block 510. Block 520 represents the operation of adding the actual or simulated score for the hypothesis to the total discrimination score for that hypothesis to obtain a revised score. In block 530, the new top choice selected would be the hypothesis with the best revised score.

After any of the preferred embodiments of the rescoring system has accepted or corrected the top choice speech element sequence the new, possibly corrected sequence will be presented to the user or sent to an application program in block 140, as if it had come directly from the base recognition system.

In one embodiment, error correction data or other feedback information could be collected from the user, as represented by block 150 in FIG. 1. For example, the error correction information could be collected from the speaker or a third party transcribing or correcting the output text. Optionally, an embodiment of the invention could use its own user interface to collect additional information from the user.

One embodiment of the present invention would collect statistics on the behavior of the base recognition system and would be able to predict which errors are more likely to occur in which situations. For example, the base recognition system might be observed to repeatedly misrecognize the command “[go to bottom]”. These misrecognitions might occur because the speaker actually says “go duh bottom,” because the unstressed function word “to” gets reduced in natural speech. Furthermore, if the base recognition system models this phrase as a sequence of phonemes, such as “/g oh t u b aa t ah m/”, and shares the acoustic models for the phonemes among all the words in the vocabulary, the base system may be unable to correct the errors without causing additional errors elsewhere. That is, training the acoustic models for the phonemes “/t U/” with the reduced instance spoken “duh” would degrade the performance on all instances in which “/t/” or “μl” are not reduced. Furthermore, because the training data for the phonemes “/t U/” include many non-reduced instances, the models will be a compromise and the system may still misrecognize “[go to bottom]” even after training that has degraded performance on the non-reduced instances.

In a further embodiment of the present invention as represented in block 160, the collected information could be used to perform at least one of improving the second set of scoring models or training the base speech recognition process. For example, in one implementation of this embodiment, these detected misrecognitions would be used to build discriminative models discriminating between “[go to bottom]” and any of the phrases that it is misrecognized to be. These models would be separate from and external to the base recognizer and therefore could not affect the acoustic models for phonemes shared by other word models and thus would not produce additional errors elsewhere. Thus, one or more embodiments of the present invention would be able to correct errors that the base recognizer could not or does not correct by itself, although in principle an improved base recognizer could be designed.

In an alternative embodiment, the performance of the base recognition system itself could also be improved. For example, an embodiment of the present invention could save the speech data for the instances of misrecognition. In the case of repeated errors, or errors that the user designates as important, this embodiment could repeatedly call the base system training mechanism to train on the particular data, causing the base recognition system to treat this data as if it had been repeated multiple times and therefore giving it more weight in the training than if it had occurred only once.

By saving a copy of the speech models in the base recognizer before and after the automated repeated training, this embodiment could implement the shadow modeling and adaptive training techniques of co-pending application Ser. No. 10/348,967 not only for its own models, but also for those of the base recognizer.

Additionally, the preferred embodiment would use other improved modeling techniques both for the acoustic models and for the language model, without having to replace the base recognition system.

This invention provides in some embodiments a means for an external recognition system to correct errors made by a base recognition system without changing the models used by the base system. This external system reduces the need to trade-off modeling one situation with others and allows errors to be corrected without as great an effect of introducing other errors.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

The present invention allows improvement in a base speech recognition system without the necessity of changing the base speech recognition system itself (although such changes could be made if desired). It even allows improvement without access to the source code of the underlying base speech recognition system. For example, this invention could operate as an add-on product to a commercially available recognition system.

1. A method for speech recognition for use with a base speech recognition process, but which does not affect scoring models in the base speech recognition process, comprising:
obtaining an output hypothesis from a base speech recognition process that uses a first set of scoring models;
obtaining a set of alternative hypotheses;
scoring the output hypothesis and each one in the set of alternative hypotheses based on a second set of different scoring models that is separate from and external to the base speech recognition process and does not affect the scoring models thereof; and
selecting a hypothesis with a best score.

2. The method as defined in claim 1, further comprising
presenting the best scoring hypothesis.
collecting error correction or other feedback information,
using the collected information to perform at least one of improving the second set of scoring models or training the base speech recognition process.

3. The method as defined in claim 1, wherein the second set of scoring models may be changed without changing the first set of models or the scores or relative rankings produced by the first set of models.

4. The method as defined in claim 1, wherein the obtaining a list of alternative hypotheses step comprises selecting a reduced number of hypotheses with good scores as determined by the first set of scoring models, wherein the reduced number is less than all of the hypotheses considered by the first speech recognition process.

5. The method as defined in claim 4, further comprising the steps of
comparing two hypotheses with good scores to determine which speech element or elements differ; and
rescoring with the second set of scoring models at least one of the speech element or elements that differ.

6. The method as defined in claim 1, wherein the obtaining a list of alternative hypotheses step comprises adding at least one new hypothesis to the output hypothesis from the first speech recognition process.

7. The method as defined in claim 6, wherein the adding at least one new hypothesis step comprises the steps of
detecting a confusable one or more speech elements in the output hypothesis; and
selecting an alternative for at least one of the confusable one or more speech elements; and
creating as an alternative hypothesis a new hypothesis using the alternative speech element.

8. The method as defined in claim 7, wherein the selection of the alternative for the at least one confusable speech element is made from a database of confusable speech elements or speech elements that are often deleted in speech.

9. The method as defined in claim 1, wherein the second set of scoring models includes at least one of an improved set of acoustic models and a language model.

10. The method as defined in claim 1, wherein if the second set of scoring models does not have data pertaining to any of the speech elements which differ between the top choice hypothesis and an alternate hypothesis, then not changing the relative rank between the top choice hypothesis and the said alternate hypothesis.

11. The method as defined in claim 1, wherein the second set of scoring models includes at least one discriminative scoring model.

12. The method as defined in claim 11, further comprising training the discriminative model by a back-propagation algorithm to discriminate between speech elements where error information has been collected for these speech elements.

13. The method as defined in claim 11, further comprising training the discriminative scoring model using less than 50% of the training data normally used to train a standard scoring model.

14. The method as defined in claim 11, wherein the scoring step comprises calculating a different discrimination score between the output hypothesis and each hypothesis in the set of the alternative hypotheses; and
wherein the selecting a hypothesis step comprises selecting a best hypothesis based at least in part on the discrimination scores.

15. The method as defined in claim 11, wherein the scoring step comprises
obtaining an actual or a simulated score for each of a plurality of hypotheses;
for each of the plurality of hypotheses with the actual or simulated scores, obtaining a total discrimination score for the hypothesis by obtaining a discrimination score for the hypothesis paired with a different hypothesis, and then summing a plurality of the discrimination scores for that given hypothesis;
adding the actual or simulated score for the hypothesis to the total discrimination score for that hypothesis to obtain a revised score; and
wherein the selecting a hypothesis step comprises selecting a hypothesis with the best revised score.

16. The method as defined in claim 2, wherein the collecting information step comprises presenting a screen interface to a user for receiving correction information.

17. The method as defined in claim 2, wherein the collecting information step comprises collecting statistics on errors of the first speech recognition process.

18. The method as defined in claim 2, wherein the using the collected information step comprises the steps of
determining selected errors that are repeated in the first speech recognition process; and
repeatedly calling a training mechanism in the first speech recognition process to train on the selected errors to thereby give more weight in the training to these selected errors.

19. A program product for speech recognition for use with a base speech recognition process, but which does not affect scoring models in the base speech recognition process, comprising machine-readable program code that, when executed, will cause a machine to perform the following steps:
obtaining an output hypothesis from a base speech recognition process that uses a first set of scoring models;
obtaining a set of alternative hypotheses;
scoring the output hypothesis and each one in the set of alternative hypotheses based on a second set of different scoring models that is separate from and external to the base speech recognition process and does not affect the scoring models thereof; and
selecting a hypothesis with a best score.

20. The program product as defined in claim 19, further comprising program code for performing the steps:
presenting the best scoring hypothesis.
collecting error correction or other feedback information,
using the collected information to perform at least one of improving the second set of scoring models or training the base speech recognition process.

21. The program product as defined in claim 19, wherein the second set of scoring models may be changed without changing the first set of models or the scores or relative rankings produced by the first set of models.

22. The program product as defined in claim 19, wherein the obtaining a list of alternative hypotheses step comprises selecting a reduced number of hypotheses with good scores as determined by the first set of scoring models, wherein the reduced number is less than all of the hypotheses considered by the first speech recognition process.

23. The program product as defined in claim 22, further comprising program code for performing the steps of
comparing two hypotheses with good scores to determine which speech element or elements differ; and
rescoring with the second set of scoring models at least one of the speech element or elements that differ; and
wherein the selecting a hypothesis step comprises selecting from the compared rescored hypotheses a best a hypothesis with a best score.

24. The program product as defined in claim 19, wherein the obtaining a list of alternative hypotheses step comprises adding at least one new hypothesis to the output hypothesis from the first speech recognition process.

25. The program product as defined in claim 24, wherein the adding at least one new hypothesis step comprises the steps of
detecting a confusable one or more speech elements in the output hypothesis; and
selecting an alternative for at least one of the confusable one or more speech elements; and
creating as an alternative hypothesis a new hypothesis using the alternative speech element.

26. The method as defined in claim 25, wherein the selection of the alternative for the at least one confusable speech element is made from a database of confusable speech elements or speech elements that are often deleted in speech.

27. The program product as defined in claim 19, wherein the second set of scoring models includes at least one of an improved set of acoustic models and a language model.

28. The program product as defined in claim 19, wherein if the second set of scoring models does not have data pertaining to any of the speech elements which differ between the top choice hypothesis and an alternate hypothesis, then not changing the relative rank between the top choice hypothesis and the said alternate hypothesis.

29. The program product as defined in claim 19, wherein the second set of scoring models includes at least one discriminative scoring model.

30. The program product as defined in claim 29, further comprising program code for training the discriminative model by a back-propagation algorithm to discriminate between speech elements where error information has been collected for these speech elements.

31. The program product s defined in claim 29, further comprising program code for training the discriminative scoring model using less than 50% of the training data normally used to train a standard scoring model.

32. The program product as defined in claim 29, wherein the scoring step comprises calculating a different discrimination score between the output hypothesis and each hypothesis in the set of the alternative hypotheses; and
wherein the selecting a hypothesis step comprises selecting a best hypothesis based at least in part on the discrimination scores.

33. The program product as defined in claim 29, wherein the scoring step comprises
obtaining an actual or a simulated score for each of a plurality of hypotheses;
for each of the plurality of hypotheses with the actual or simulated scores, obtaining a total discrimination score for the hypothesis by obtaining a discrimination score for the hypothesis paired with a different hypothesis, and then summing a plurality of the discrimination scores for that given hypothesis;
adding the actual or simulated score for the hypothesis to the total discrimination score for that hypothesis to obtain a revised score; and
wherein the selecting a hypothesis step comprises selecting a hypothesis with the best revised score.

34. The program product as defined in claim 20, wherein the collecting information step comprises presenting a screen interface to a user for receiving correction information.

35. The program product as defined in claim 20, wherein the collecting information step comprises collecting statistics on errors of the first speech recognition process.

36. The program product as defined in claim 20, wherein the using the collected information step comprises the steps of
determining selected errors that are repeated in the first speech recognition process; and
repeatedly calling a training mechanism in the first speech recognition process to train on the selected errors to thereby give more weight in the training to these selected errors.

37. A system for speech recognition for use with a base speech recognition process, but which does not affect scoring models in the base speech recognition process, comprising:
a component for obtaining an output hypothesis from a base speech recognition process that uses a first set of scoring models;
a component for obtaining a set of alternative hypotheses;
a component for scoring the output hypothesis and each one in the set of alternative hypotheses based on a second set of different scoring models that is separate from and external to the base speech recognition process and does not affect the scoring models thereof; and
a component for selecting a hypothesis with a best score.
